(19) United States
(12) Patent Application Publication
(10) Pub. No.: US 2007/0073816 A1
(43) Pub. Date: Mar. 29, 2007

(54) Method and system for providing increased information and improved user controls for electronic mail return receipts

(76) Inventors: Shruti Kumar, Littleton, MA (US); Niklas Heidloff, Salzkotten (DE); Michael R. O'Brien, Westford, MA (US)

Correspondence Address: LOTUS AND RATIONAL SOFTWARE;McGuinness & Manaras LLP, 125 NAGOG PARK, ACTON, MA, 01720, US

(21) Appl. No.: 11/236,909

(22) Filed: Sep. 28, 2005

(51) Int. Cl. G06F 15/16

(52) U.S. Cl. 709/206

(57) ABSTRACT

A system for providing return receipts in an electronic mail (“email”) system. The system provides information in the receipts enabling a user to track messages, and provides controls to sending and receiving users to effectively manage the return receipt feature. The system is not limited to providing receipt information regarding whether the message has been delivered and read, and can provide a variety of information regarding how the message was processed after its receipt. The disclosed system also provides a rich set of options with regard to sending user and receiving user controls over the return receipt feature. A sending user can request that specific receipt information be provided, for certain messages, and/or can individually select specific types of receipt information. The receiving user is also provided with controls for enabling, disabling and/or applying specific conditions to all or certain types of return receipts. In a further aspect of the disclosed system, the return receipt feature can be managed via a globally defined policy.

### FIELD OF THE INVENTION

The present invention relates generally to electronic messaging systems such as electronic mail (“email”), and more specifically to a method and system for providing increased information and an improved control mechanism for electronic mail return receipts.

### BACKGROUND OF THE INVENTION

As it is generally known, existing electronic mail (“email”) software application client programs sometimes include a return receipt feature. Examples of existing systems that can generate message delivery and message read receipts to a message sender include Lotus Notes®, provided by International Business Machines Corporation, and Microsoft Outlook, provided by Microsoft Corporation. However, existing systems have significant shortcomings with regard to the information provided by the receipts they generate, and with regard to the user controls they provide.

Existing systems do not provide information in the receipt that is sufficient to completely track a message. For example, some receipts generated by existing systems may only indicate when a message was delivered and opened. Such receipts are limited in their usefulness since they fail to include many other types of potentially useful information. Many specific types of useful information are not included in message receipts returned to senders by existing email systems, including how long the message was opened for, whether the message was forwarded, whether the message was deleted, whether a specific rule was applied to the message, whether the message was moved to a folder, whether the message was blocked, whether the mail was not opened, and other information.

Additionally, user controls over receipts provided for messages are significantly limited in existing systems. For example, existing systems provide receiving users with few options for controlling receipt generation. This limitation can result in a variety of undesirable effects. For example, if a sender requests return receipts for large numbers of messages, large amounts of return receipt message traffic may be created. Further, if an incoming message is “spam” (an unsolicited commercial email message), the return of a receipt message may have the undesirable effect of confirming that the original message was sent to a live email address. Receiving users accordingly would benefit in many ways from increased control over the return receipt feature.

For the above reasons and others, it would be desirable to have a new return receipt mechanism for messaging systems such as electronic mail, that provides more information to sending users than is provided by existing systems, and that gives both sending users and receiving users better control over the return receipt feature.

### SUMMARY OF THE INVENTION

To address the above described and other shortcomings of existing systems, a new method and system for providing a return receipt feature in an electronic mail (“email”) system are disclosed. The disclosed return receipt mechanism returns notification email messages to a sending user that allow improved tracking of a previously sent message.

The disclosed system also provides rich and flexible controls to sending and receiving users that allow them to effectively manage the return receipt feature. The message tracking options provided by the disclosed system may be controlled by way of one or more globally defined return receipt policies.

With regard to the information provided in the receipt messages, the disclosed system is not limited to indicating whether a previously sent message has simply been delivered and read. Instead, message tracking notifications provided by the disclosed system can provide various specific types of messaging tracking information. Any specific type of message tracking notification may be provided. For example, message tracking information returned to a sending user may include information such as a time and date when the message was received, a time and date at which the message was opened, a time duration the message was opened for, indication of whether and to whom the message was forwarded, an indication of whether the message was deleted, indication of whether the message was moved into a folder, indication of whether a message processing rule was applied to the message as part of its processing by email client program on the receiving system, and/or any other useful message tracking information that may be requested by the sending in a specific embodiment.

The disclosed system provides both the message sender and message receiver with controls over message tracking notifications. In one embodiment, a sending user can indicate the specific types of notifications to be requested for individual messages. Alternatively, a sending user can indicate the types of notifications to be requested for all sent messages. Additionally, the disclosed system may be embodied such that the sending user can request that certain types of receipt notifications be requested under certain specified circumstances. Various specific types of notifications may be requested. For example, a sending user may request notification in the event that a message was not opened for a specified time period. Multiple notifications may be requested for an individual message, each corresponding to a corresponding message processing event. Alternatively, composite notifications may be requested indicating the occurrence of a combination of events. For example, the sending user may request individual notification messages be returned when a message is opened, forwarded, and/or deleted. In such a scenario, a message that is opened, forwarded, and then deleted, might cause the sender to be sent three receipt messages, generated when the message was opened, forwarded and deleted respectively. Alternatively, the disclosed system may be embodied such that the sending user can request a single receipt notification be generated in response to a sent message being opened, forwarded, and deleted.

The receiving user is also provided with controls for enabling, disabling and/or applying specific conditions to specific return receipt notifications. As a result, a receiving user can, for example, set a condition allowing message read receipt notifications to be returned to sending users only when received messages are kept open for more than a specified minimum time period. In another aspect of the disclosed system, a receiving user can disable, enable, or otherwise control return receipt notifications generated for a particular sender or group of senders.

In a further aspect of the disclosed system, the return receipt feature can be managed via one or more globally defined return receipt policies. In such an embodiment, depending on the global policy, a given user will be allowed either full or limited control over operation of the return receipt feature. A global return receipt policy can be used by an administrator user to define levels of user control over the return receipt feature for specific users, or for groups of users. A global policy may further specifically control the information return receipt notifications must contain. The global return receipt function of the disclosed system may be useful in many specific situations. For example, based on a global return receipt policy, a user performing a time critical task may be permitted to request receipt notifications indicating that a message has been delivered, that a message has been read, or that a message has not been read after an indicated time period following its delivery. In another example of an advantageous use, a global return receipt policy may be defined that allows a user doing work on a confidential task to request receipt notifications indicating that a message has been delivered, that a message has been forwarded, and to whom the message was forwarded to. Various other examples of advantageous applications of the disclosed global return receipt policy feature will be apparent to those skilled in the art.

Thus there is disclosed a new message receipt mechanism for electronic mail, that provides more information in the returned receipt than is provided by existing systems, and that gives both message sending users and message receiving users better controls for managing the return receipt feature.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 shows software components operating in an illustrative embodiment of the disclosed system;

FIG. 2 is a block diagram illustrating the use of global return receipt policies to control operation in an embodiment of the disclosed system;

FIG. 3 is a flow chart illustrating steps performed to request message tracking options when sending one or more messages in an embodiment of the disclosed system;

FIG. 4 is a flow chart illustrating steps performed to control message tracking notifications with regard to one or more received messages in an embodiment of the disclosed system;

FIG. 5 is a block diagram illustrating a use case for an embodiment of the disclosed system; and

FIG. 6 shows a portion of an illustrative graphical user interface provided by an embodiment of the disclosed system to obtain user settings.

### DETAILED DESCRIPTION OF EXEMPLARY EMBODIMENTS

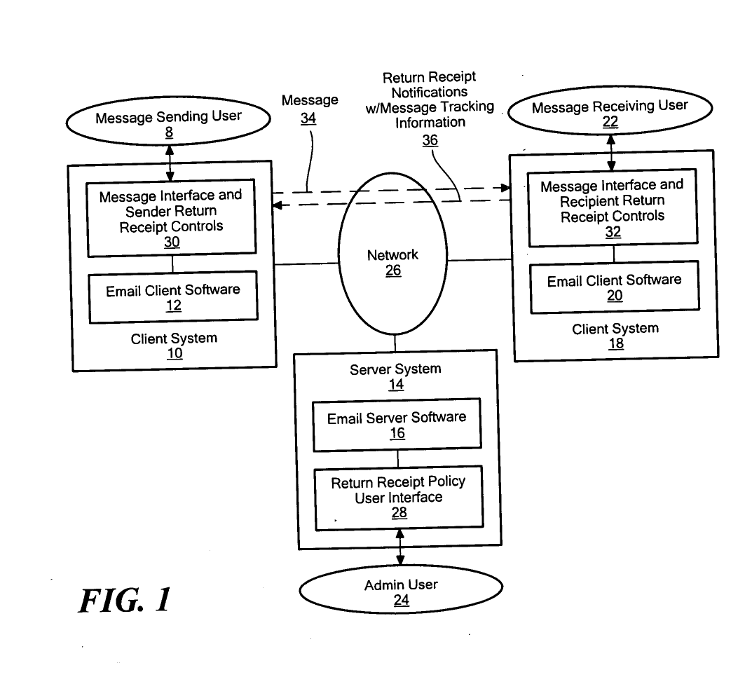

As shown in FIG. 1, in an embodiment of the disclosed system, a number of software components execute on various computer systems, shown for purposes of illustration including a client system 10, a client system 18, and one or more server system(s) 14. The client systems 10 and 18, and the server system 14, may, for example, each include at least one processor and program storage, such as memory, for storing program code executable on the processor, and one or more input/output devices and/or interfaces, such as data communication or other peripheral devices and/or interfaces. The computer systems 10, 14 and 18 are communicably connected by a data communication network 26, such as a Local Area Network (LAN), the Internet, or the like, which may also be connected to a number of other client and/or server computer systems. The computer systems 10, 14 and 18 may further include any appropriate type of operating system software.

As shown in FIG. 1, a message sending user 8 uses the message interface and sender return receipt controls 30 to create an email message 34 addressed to the message receiving user 22, and also to indicate the message tracking options to be associated with that message. Any appropriate type of graphical user interface may be used to provide the message interface and sender receipt controls 30. As further described below, the message tracking options that can be associated with a given message by a sending user may be defined by a number of globally administered return receipt policies. The message interface and sender return receipt controls 30 are, for example, provided to the message sending user 8 by email client software 12. After the message tracking options for the email message 34 are obtained from the message sending user 8, the email message 34 is then sent to the message receiving user 22 over the network 26.

Following receipt of the email message 34 at the client system 18, the email client software 20 operates to provide a message interface and recipient return receipt controls 32 to the message receiving user 22. The message interface and recipient return receipt controls 32 may be provided using any appropriate type of graphical user interface. The message interface and recipient return receipt controls 32 enable the message receiving user 22 to open and read the message 34, to be presented with indications of which specific message tracking options are associated with the message 34, and to indicate which of the message tracking options associated with the message 34 are to be allowed, and which are to be disabled. As further described below, the message tracking options that may be disabled by a message recipient such as the message receiving user 22 may alternatively, or in addition, be defined by a number of globally administered return receipt policies. One or more return receipt notification messages 36, including various specific types of message tracking information, are then be sent back to the message sending user 8, informing the message sending user 8 of actions taken and/or not taken with regard to the message 34 subsequent to it being sent. Each of the notification messages 36 may indicate one or more events that have occurred with regard to the message, and that enable the sending user 8 to effectively track the message.

Messages such as the message 34 and notifications 36 may be communicated between client system 10 and the client system 18 using appropriate electronic mail protocols for a given embodiment. For example, the Simple Mail Transfer Protocol (SMTP) or the like may be used to define the message format and route the messages and return receipt notifications through the network 26 via one or more electronic mail server systems, such as the server system 14, which is shown including email server software 16 for storing received messages. The email server software 16 may further use any appropriate access protocol, such as POP3 (Post Office Protocol 3), IMAP4 (Internet Message Access Protocol 4), or the like, to communicate with the e-mail client programs 12 and 20.

As further shown in FIG. 1, an administrator user 24 may also use a return receipt policy user interface 28 that may be provided by the email server software 16 to define one or more global return receipt policies stored by the email server software 16. The return receipt policy user interface 28 may be embodied using any appropriate graphical user interface.

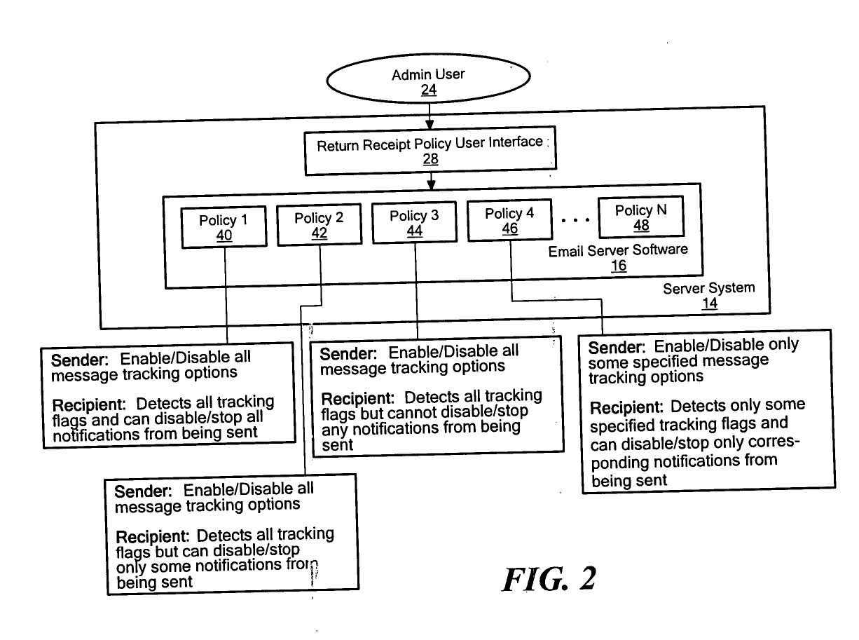

Now as further shown in FIG. 2, the administrator user 24 uses the return receipt policy user interface 28 to define multiple global return receipt policies, shown for purposes of illustration as policy 1 40, policy 2 42, policy 3 44, policy 4 46, etc., through policy N 48. The policies defined through the return receipt policy user interface 28 define which message tracking options can be requested by a sending user, and which message tracking options can be disabled or stopped by a recipient user. The policies defined through the return receipt policy user interface 28 are associated with and applied to groups of one or more users, and allow the administrator user 24 to effectively control resources. A sender and a recipient for a given message may be associated with the same or different global policies.

For example, policy 1 40 allows senders to enable or disable all possible message tracking options. Policy 1 40 also allows recipient users to detect all messaging tracking flags associated with a received message, and to disable or otherwise prevent all corresponding notifications from being sent. Policy 2 42 allows senders to enable or disable all message tracking options, and allows recipient users to detect all message tracking flags associated with a received message. However, policy 2 42 only allows recipient users to disable or prevent some types of notifications from being sent. Policy 3 44 allows senders to enable or disable all message tracking options, and allows recipients to detect all message tracking flags associated with a received message. Policy 3 44 does not allow recipient users to disable or otherwise prevent any notifications.

As also shown in the example of FIG. 2, policy 4 46 allows senders to enable or disable only some specific message tracking options. Similarly, policy 4 46 only allows detection by recipients of some specific message tracking flags associated with a received message, and only allows recipients to disable or prevent notifications corresponding to the message tracking flags that it allows to be detected.

Those skilled in the art will recognize that the policies shown in FIG. 2 are only examples of specific return receipt policies that may be defined and used in an embodiment of the disclosed system, and that the scope of the present invention is not limited thereto. Accordingly, any specific policy with regard to message tracking controls for senders and recipients may be defined and used. Moreover, any specific number of policies may be defined and used in a given embodiment or implementation.

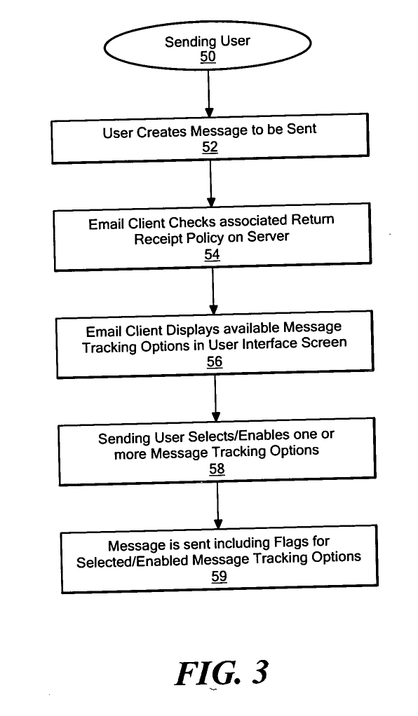

FIG. 3 is a flow chart illustrating steps performed by a user acting as a sending user 50 to send a message using an embodiment of the disclosed system, and to track processing of the message after it has been sent. At step 52, the sending user 50 creates the message to be sent, for example through a graphical user interface provided by an email client application program. At step 54, email client software checks a return receipt policy associated with the sending user 50. The return receipt policy checked at step 54 may, for example, be stored by email server software located on a server computer system. At step 56, the email client software displays the available message tracking options defined by the return receipt policy checked at step 54. The available message tracking options may be presented using any appropriate graphical user interface. For example, the message tracking options may be presented to the user in a user interface screen including a number of check boxes, or in any other specific manner as may be appropriate for a given embodiment. At step 58, the sending user 50 uses the user interface screen presented at step 56 to select or otherwise enable one or more message tracking options to be associated with the message created at step 52. For example, those message tracking options selected at step 58 may be represented in the message created at step 52 by one or more corresponding flags or other indicators sent together with, or otherwise associated with the message. At step 59 the message and indications of the selected message tracking options are sent to a recipient user.

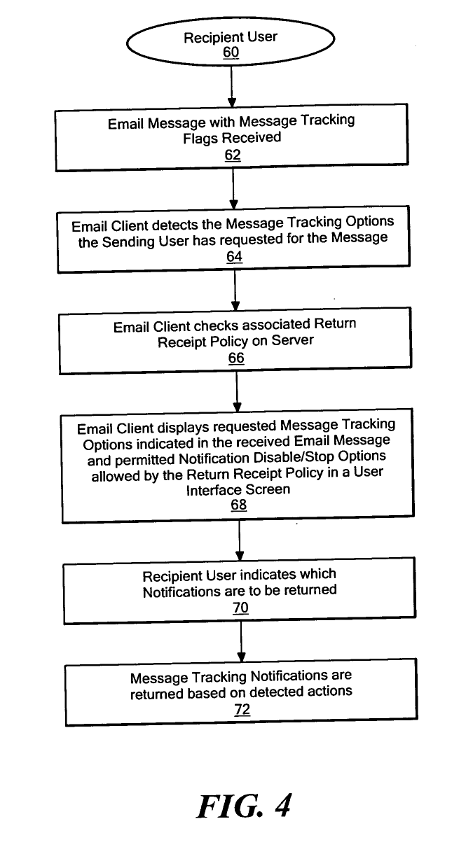

FIG. 4 is a flow chart showing a series of steps performed with regard to controlling return receipt notification messages returned to a sending user. As shown in FIG. 4, at step 62 an email message is received for a recipient user 60. The message received at step 62 includes, for example, one or more flags indicating corresponding tracking options indicated by a sending user. The message tracking options are detected based on such flags by email client software at step 64. At step 66, the email client checks a return receipt policy stored, for example, by server software executing on a server computer system. The return receipt policy checked at step 66 defines which message checking options the recipient user 60 is permitted to disable or otherwise prevent notifications from being generated for. At step 68, the email client software provides a user interface screen indicating which message tracking options have been requested by the sending user for the received message. The user interface screen provided at step 68 also enables the recipient user 60 to disable certain message tracking notifications, as permitted by the associated return receipt policy checked at step 66.

Through the user interface screen provided at step 68, at step 70 the recipient user indicates the message tracking notifications that may be returned to the sending user for the message received at step 62. Those message tracking notifications indicated at step 70 are then returned at step 72 based on detection of corresponding actions, inaction for a specified period, or other processing events with regard to the message received at step 62.

For purposes of illustration, steps 58 and 70 in FIGS. 3 and 4 are performed with respect to individual messages. However, the disclosed system is not limited to such an embodiment. Accordingly, specific types of return receipt notifications may be requested for multiple messages, and specific types of return receipt notifications may be disabled for multiple messages. For example, specific types of return receipt notifications may be requested in a single step for messages sent by a given user, and specific types of return receipt notifications may be disabled in a single step for all received messages. Similarly, return receipt notification request types may be defined on a per destination user or user group basis, and specific types of notifications may be disabled based on the sending user or for a group of sending users. Depending on the specific embodiment or configuration, such definitions may be subject to one or more globally administered return receipt policies.

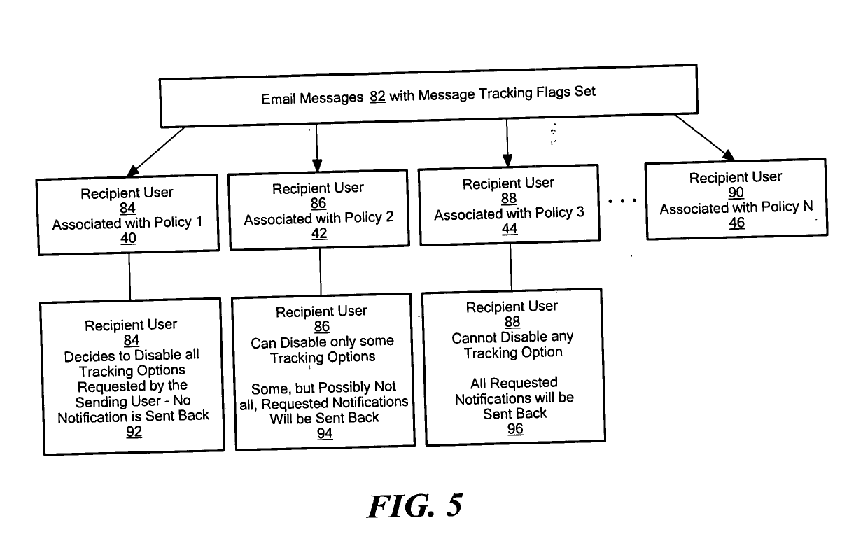

FIG. 5 is a block diagram illustrating a use case involving an embodiment of the disclosed system. As shown in FIG. 5, a number of email messages 82 having one or more message tracking flags set are transmitted from one or more sending users. When one of the messages 82 is sent to a recipient user 84 associated with return receipt policy 1 40, at step 92 the recipient user 84 decides to disable all tracking options requested by the sending user, and accordingly no tracking notification is sent back. When one of the messages 86 that is sent to a recipient user 86 associated with policy 2 42, then at step 94 the recipient user 86 can only disable some tracking options. Accordingly, at step 94, some but possibly not all requested notifications will be sent back to the sending user. In the case where one of the messages 82 is sent to a recipient user 88 associated with policy 3 44, the recipient user 88 cannot disable any tracking options, and accordingly all requested notifications will be sent back to the requesting user if the corresponding trigger events occur.

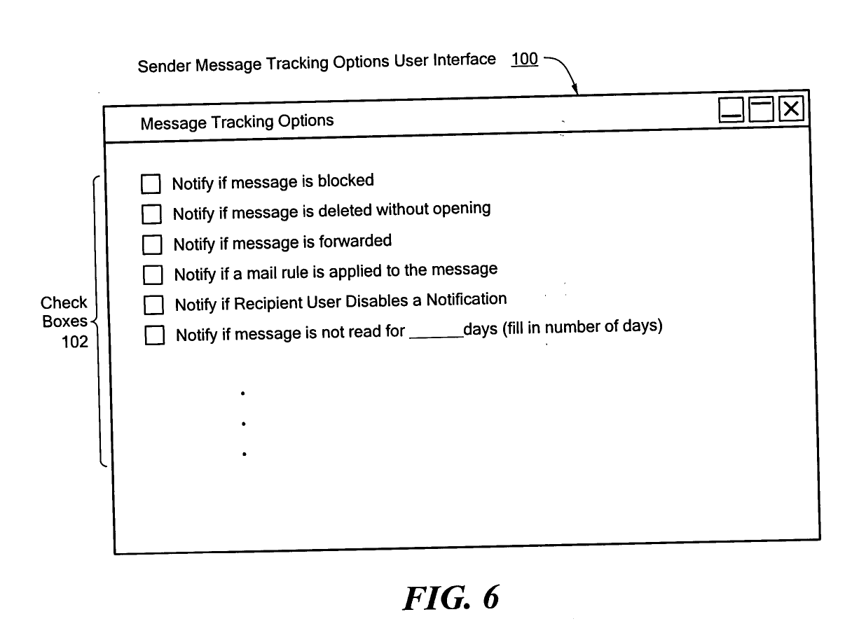

FIG. 6 is an example of a pop-up user interface screen that allows a user sending a message to indicate which message tracking options are requested for that message. A number of check boxes 102 are provided to enable the user to select one or more message tracking options by checking an associated check box. In the example of FIG. 6, the user can select to be notified in the event that the message is blocked from being received by the recipient user, if the message is deleted without being opened, if the message is forwarded, if a mail rule is applied to the message, if the recipient user has disabled a notification type for this message, if the message is not read for some specified number of days, and/or based on the occurrence of other events. The user interface 100 is an example of a portion of the message interface and sender return receipt controls 30 shown in FIG. 1. The specific message tracking options provided in the user interface 100 may be determined, at least in part, based on a global return receipt policy associated with the sending user. Further, the user interface 100 may be provided for a single message to be sent, or for multiple messages to be sent. The user interface 100 is only one example of a possible user interface that may be used to determine the message tracking options for a sending user, and is given only for purposes of explanation an illustration. Alternatively, any other appropriate type of user interface may be used for this purpose.

With regard to the message interface and recipient return receipt controls 32 of FIG. 1, a pop-up user interface screen may also be used to enable the recipient user to disable certain notifications. In such an embodiment, check boxes may also be used to capture user indications that specific requested notifications are to be disabled. However, in the case where a global return receipt policy prevents a requested notification from being disabled, no corresponding check box would be provided. Such unavailable options might, for example, be grayed out, indicating that they have been requested by the sender, but cannot be disabled by the recipient user Alternatively, any other appropriate type of user interface may be used for this purpose as well. Similarly, with regard to the return receipt policy user interface 28 of FIG. 1, any specific type of user interface may be employed to allow an administrator user to define one or more global return receipt policies.

The receipt notifications may be provided as ordinary email messages, including text and/or graphical indications of the processing events they represent, as well as some indication of the previously sent message they correspond to. For example, a return receipt notification in an embodiment of the disclosed system could include a message identifier of the associated message, a TO: field indicating the user to which the message was sent, a FROM: field indicating the user that sent the message, and any other relevant information, including time and date, users to whom the message was forwarded, etc., regarding the processing event or events that caused the notification to be sent. The appearance of the return receipt notifications is further dependent on the email client user interface, and any specific format may be used in this regard.

The figures include block diagram and flowchart illustrations of methods, apparatus(s) and computer program products according to an embodiment of the invention. It will be understood that each block of FIGS. 1-5, and combinations of these blocks, can be implemented by computer program instructions. These computer program instructions may be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using wireless, baseband signaling or broadband signaling techniques, including carrier wave signaling techniques, such as over computer or telephone networks via a modem.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative program command structures, one skilled in the art will recognize that they may be embodied using a variety of specific command structures.

We claim:

1. A method of providing a return receipt mechanism in an electronic mail system, comprising:
automatically generating an electronic receipt for an electronic mail message sent through said electronic mail system, wherein said electronic receipt includes an indication of processing of said electronic mail message at a receiving system, wherein said generating is responsive to detection of said processing of said electronic mail message at said receiving system, wherein said processing of said electronic mail message at said receiving system is other than receiving said electronic mail message at said receiving system and reading of said electronic mail message by a receiving user; and
automatically sending said electronic receipt to a sending user for said electronic mail message via said electronic mail system.

2. The method of claim 1, wherein said indication of processing of said electronic mail message at said receiving system includes indication of a time and date said electronic mail message was received at said receiving system.

3. The method of claim 1, wherein said indication of processing of said electronic mail message at said receiving system includes an indication of a time and date said electronic mail message was opened by said receiving user.

4. The method of claim 1, wherein said indication of processing of said electronic mail message at said receiving system includes an indication of a time duration for which said electronic mail message was opened by said receiving user.

5. The method of claim 1, wherein said indication of processing of said electronic mail message at said receiving system includes an indication of whether said electronic mail message was forwarded.

6. The method of claim 5, wherein said indication of processing of said electronic mail message at said receiving system further includes an identity of another user to whom said electronic mail message was forwarded.

7. The method of claim 1, wherein said indication of processing of said electronic mail message at said receiving system further includes an indication of whether said electronic mail message was moved into a folder structure.

8. The method of claim 1, wherein said indication of processing of said electronic mail message at said receiving system includes an indication of whether a message processing rule was applied to said electronic mail message.

9. The method of claim 1, wherein said indication of processing of said electronic mail message at said receiving system includes an indication of whether said electronic mail message was deleted without being opened.

10. The method of claim 1, wherein said indication of processing of said electronic mail message at said receiving system includes an indication of whether said electronic mail message was blocked.

11. The method of claim 1, wherein said indication of processing of said electronic mail message at said receiving system includes an indication of whether said receiving user has disabled generation of electronic receipts.

12. The method of claim 1, wherein said indication of processing of said electronic mail message at said receiving system includes an indication of whether said electronic mail message was opened within a predetermined time period after said electronic mail message was received.

13. The method of claim 1, further comprising providing a sending user control to said sending user through which said sending user can request at least one type of processing of said electronic mail message at said receiving system to be indicated by said electronic receipt from a plurality of processing types.

14. The method of claim 1, further comprising providing a receiving user control to said receiving user through which said receiving user can select ones of a plurality of types of processing of said electronic mail message at said receiving system that can be indicated by said electronic receipt.

15. The method of claim 1, further comprising:
determining a global return receipt policy, wherein said global return receipt policy controls which users are permitted to select which types of processing of electronic mail messages at receiving systems are indicated by said electronic receipt.

16. A system for providing a return receipt mechanism in an electronic mail system, said system including a computer readable medium having program code stored thereon, said program code comprising:
program code for automatically generating an electronic receipt for an electronic mail message sent through said electronic mail system, wherein said electronic receipt includes an indication of processing of said electronic mail message at a receiving system, wherein said generating is responsive to detection of said processing of said electronic mail message at said receiving system, wherein said processing of said electronic mail message at said receiving system is other than receiving said electronic mail message at said receiving system and reading of said electronic mail message by a receiving user; and
program code for automatically sending said electronic receipt to a sending user for said electronic mail message via said electronic mail system.

17. The system of claim 16, wherein said indication of processing of said electronic mail message at said receiving system includes indication of a time and date said electronic mail message was received at said receiving system.

18. The system of claim 16, wherein said indication of processing of said electronic mail message at said receiving system includes an indication of a time and date said electronic mail message was opened by said receiving user.

19. The system of claim 16, wherein said indication of processing of said electronic mail message at said receiving system includes an indication of a time duration for which said electronic mail message was opened by said receiving user.

20. The system of claim 16, wherein said indication of processing of said electronic mail message at said receiving system includes an indication of whether said electronic mail message was forwarded.

21. The system of claim 20, wherein said indication of processing of said electronic mail message at said receiving system further includes an identity of another user to whom said electronic mail message was forwarded.

22. The system of claim 16, wherein said indication of processing of said electronic mail message at said receiving system further includes an indication of whether said electronic mail message was moved into a folder structure.

23. The system of claim 16, wherein said indication of processing of said electronic mail message at said receiving system includes an indication of whether a message processing rule was applied to said electronic mail message.

24. The system of claim 16, wherein said indication of processing of said electronic mail message at said receiving system includes an indication of whether said electronic mail message was deleted without being opened.

25. The system of claim 16, wherein said indication of processing of said electronic mail message at said receiving system includes an indication of whether said electronic mail message was blocked.

26. The system of claim 16, wherein said indication of processing of said electronic mail message at said receiving system includes an indication of whether said receiving user has disabled generation of electronic receipts.

27. The system of claim 16, wherein said indication of processing of said electronic mail message at said receiving system includes an indication of whether said electronic mail message was opened within a predetermined time period after said electronic mail message was received.

28. The system of claim 16, further comprising program code for providing a sending user control to said sending user through which said sending user can request at least one type of processing of said electronic mail message at said receiving system to be indicated by said electronic receipt from a plurality of processing types.

29. The system of claim 16, further comprising program code for providing a receiving user control to said receiving user through which said receiving user can select ones of a plurality of types of processing of said electronic mail message at said receiving system that can be indicated by said electronic receipt.

30. The system of claim 16, further comprising:
program code for determining a global return receipt policy, wherein said global return receipt policy controls which users are permitted to select which types of processing of electronic mail messages at receiving systems are indicated by said electronic receipt.

31. A computer program product including a computer readable medium, said computer readable medium having program code stored thereon for providing a return receipt mechanism in an electronic mail system, said program code comprising:
program code for automatically generating an electronic receipt for an electronic mail message sent through said electronic mail system, wherein said electronic receipt includes an indication of processing of said electronic mail message at a receiving system, wherein said generating is responsive to detection of said processing of said electronic mail message at said receiving system, wherein said processing of said electronic mail message at said receiving system is other than receiving said electronic mail message at said receiving system and reading of said electronic mail message by a receiving user; and
program code for automatically sending said electronic receipt to a sending user for said electronic mail message via said electronic mail system.

32. A computer data signal embodied in a carrier wave, the computer data signal including program code for providing a return receipt mechanism in an electronic mail system, said program code comprising:
program code for automatically generating an electronic receipt for an electronic mail message sent through said electronic mail system, wherein said electronic receipt includes an indication of processing of said electronic mail message at a receiving system, wherein said generating is responsive to detection of said processing of said electronic mail message at said receiving system, wherein said processing of said electronic mail message at said receiving system is other than receiving said electronic mail message at said receiving system and reading of said electronic mail message by a receiving user; and
program code for automatically sending said electronic receipt to a sending user for said electronic mail message via said electronic mail system.

33. A system for providing a return receipt mechanism in an electronic mail system, comprising:
means for automatically generating an electronic receipt for an electronic mail message sent through said electronic mail system, wherein said electronic receipt includes an indication of processing of said electronic mail message at a receiving system, wherein said generating is responsive to detection of said processing of said electronic mail message at said receiving system, wherein said processing of said electronic mail message at said receiving system is other than receiving said electronic mail message at said receiving system and reading of said electronic mail message by a receiving user; and
means for automatically sending said electronic receipt to a sending user for said electronic mail message via said electronic mail system.
